(19) United States
(12) Patent Application Publication
(10) Pub. No.: US 2014/0049728 A1
(43) Pub. Date: Feb. 20, 2014

(54) LIGHT GUIDE PLATE, LIGHT-EMITTING UNIT AND LIQUID CRYSTAL DISPLAY DEVICE HAVING THE SAME

(71) Applicant: CHI MEI CORPORATION, Tainan City (TW)

(72) Inventors: Chih-Hung LIN, TAINAN CITY (TW); Chia-Hui YU, CHIAYI COUNTY (TW)

(73) Assignee: CHI MEI CORPORATION, Tainan City (TW)

(21) Appl. No.: 13/958,633

(22) Filed: Aug. 5, 2013

(30) Foreign Application Priority Data
Aug. 16, 2012 (TW) 101129751

(51) Int. Cl. F21V 8/00; G02F 1/1335

(52) U.S. Cl. CPC G02B 6/0015; G02F 1/133615
USPC 349/65; 362/606

(57) ABSTRACT

The present invention relates to a light guide plate, a light-emitting unit having the light guide plate and a liquid crystal display device having the light-emitting unit. The light guide plate includes a light guide layer that has dot patterns. The dot patterns are formed by coating and drying a pattern-forming ink composition on a bottom surface. The pattern-forming ink composition includes an acrylate-based resin having a saturated alicyclic group (A) and a solvent (B). By utilizing the aforementioned light guide plate, the liquid crystal display device with low color difference can be fabricated.

### RELATED APPLICATIONS

This application claims priority to Taiwan Application Serial Number 101129751, filed on Aug. 16, 2012, which is herein incorporated by reference.

### BACKGROUND

1. Field of Invention

The present invention relates to a light guide plate a light-emitting unit having the light guide plate and a liquid crystal display device having the light-emitting unit.

2. Description of Related Art

Liquid crystal display (LCD) devices have been widely applied in display apparatuses such as personal computers (PCs), televisions, portable phones. Since the LCD device itself is not a luminous body, it is necessarily configured with a surface light source or called as backlight for irradiating light and displaying images. In recent years, a side-type backlight, which is a surface light source and configured with a light source on the side of the light guide plate for transmitting the light through total reflection to a far side, is commonly applied in a thin LCD of lightweight and miniaturized notebook PCs, rather than a direct-type backlight where a reflective plate is configured in front of the light source.

In the above side-type backlight, patterns printed on a bottom surface of the light guide plate can destroy the total reflection to form irregular scattering and reflection, thereby guiding the light to a front surface of the light guide plate. A pattern-forming ink is disclosed in Japanese Patent Laid-Open Publication No. 2008-095103. The pattern-forming ink includes a polymer resin having acrylate-based resin, a crosslinking agent having 1,6-diisocyanatohexane, and a filling material. However, when the pattern-forming ink is applied, there are some problems such as excessive color difference between a light incident point and a light-emitting point, which is unacceptable to most people in this technical field. This phenomenon is getting worse in a large-size light guide plate. Accordingly, it is necessary to provide a light guide plate for reducing color difference of the conventional light guide plate.

### SUMMARY

Therefore, an aspect of the present invention provides a light guide plate. The light guide plate includes a light incident surface of incident light, a light-emitting surface of emergent light and a bottom surface opposite to the light-emitting surface. The light guide plate includes a light guide layer that has dot patterns. The dot patterns are formed by coating and drying a pattern-forming ink composition on the bottom surface. The pattern-forming ink composition includes an acrylate-based resin having a saturated alicyclic group (A) and a solvent (B).

Another aspect of the present invention provides a light-emitting unit. The light-emitting unit includes a light-emitting source and the aforementioned light guide plate.

A further aspect of the present invention provides a LCD device. The LCD device further includes the aforementioned light-emitting unit and a liquid crystal panel configured above a light-emitting surface of the light guide plate, to provide a LCD device with low color difference.

The structure of the light guide layer, the light guide plate, the light-emitting unit, the LCD device of the present invention and fabricating methods thereof are described as follows.

### Light Guide Layer

The light guide layer is obtained by coating pattern-forming ink composition onto the bottom surface of the light guide plate in printing methods such as inkjet printing, screen printing, imprint or the like, and then being dried, so as to form dot patterns as a light guide layer of the present invention.

The aforementioned pattern-forming ink composition includes the acrylate-based resin having the saturated alicyclic group (A) and the solvent (B), as described as follows.

### Acrylate-Based Resin Having Saturated Alicyclic Group (A)

The acrylate-based resin having the saturated alicyclic group (A) includes an acrylate-based monomer a-1) and a copolymerizable vinyl unsaturated monomer (a-2), and the acrylate-based monomer (a-1) has an ester group of a saturated alicyclic hydrocarbon group of 5 to 22 carbon atoms.

The aforementioned acrylate-based monomer (a-1) can be, for example, cyclopentyl acrylate, cyclohexyl acrylate, methyl cyclohexyl acrylate, trimethyl cyclohexyl acrylate, norbornyl acrylate, methyl norbornyl acrylate, benzyl norbornyl acrylate, cyano nobbornyl acrylate, isobornyl acrylate, bornyl acrylate, menthyl acrylate, fenchyl acrylate, adamantyl acrylate, dimethyl adamantyl acrylate, 2-methyl adamantyl acrylate, 2-ethyl adamantyl acrylate, cyclodeca acrylate, dicyclopentany acrylate, dicyclopentanyloxyehtyl acrylate, acrylic acid tricycle[5.2.1.0^{2,6}]decamethyl ester, cyclopentyl methacrylate, cyclohexyl methacrylate, methyl cyclohexyl methacrylate, methyl cyclohexyl methacrylate, trimethyl cyclohexyl methacrylate, norbornyl methacrylate, methyl norbornyl methacrylate, benzyl norbornyl methacrylate, cyano nobbornyl methacrylate, isobornyl methacrylate, bornyl methacrylate, menthyl methacrylate, fenchyl to methacrylate, adamantyl methacrylate, dimethyl adamantyl methacrylate, 2-methyl adamantyl methacrylate, 2-ethyl adamantyl methacrylate, cyclodeca methacrylate, dicyclopentany methacrylate, dicyclopentanyloxyehtyl methacrylate, methacrylic acid tricycle[5.2.1.0^{2,6}]decamethyl ester and the like.

Among those monomers, cyclopentyl acrylate, cyclohexyl acrylate, adamantyl acrylate, cyclohexyl methacrylate, trimethyl cyclohexyl methacrylate, isobornyl methacrylate, bornyl methacrylate, menthyl methacrylate, fenchyl methacrylate, adamantyl methacrylate, dimethyl adamantyl methacrylate, dicyclopentany methacrylate and the like are preferred. Adamantyl acrylate, cyclohexyl methacrylate, trimethyl cyclohexyl methacrylate, isobornyl methacrylate, adamantyl methacrylate, dicyclopentany methacrylate and the like are more preferred. The aforementioned acrylate-based monomer (a-1) can be used alone or in combination of two or more.

Based on the acrylate-based resin having the saturated alicyclic group (A) as 100 parts by weight, the usage amount of the acrylate-based monomer (a-1) is usually from 3 to 40 parts by weight, preferably from 4 to 35 parts by weight, and more preferably from 5 to 30 parts by weight. When the pattern-forming ink lacks the acrylate-based monomer (a-1), the light guide plate has a problem such as excessive color difference.

The aforementioned other copolymerizable vinyl unsaturated monomer (a-2) can be, for example, unsaturated carboxylic acids (anhydride) such as acrylic acid, methacrylic acid, crotonic acid, α-chloro-acrylic acid, ethyl acrylic acid, cinnamic acid, maleic acid, maleic anhydride, fumaric acid, itaconic acid, itaconic anhydride, citraconic acid, citraconic anhydride and the like; aromatic vinyl compound such as styrene, α-methyl styrene, vinyl toluene, 4-chlorostyrene, methoxystyrene and the like; maleic imide such as N-benzyl maleic imide, N-o-hydroxy benzyl maleic imide, N-m-hydroxy benzyl maleic imide, N-p-hydroxy benzyl maleic imide, N-o-methyl benzyl maleic N-m-methyl benzyl maleic imide, N-p-methyl benzyl maleic imide, N-o-methoxy benzyl maleic imide, N-m-methoxy benzyl maleic imide, N-p-ethoxy benzyl maleic imide, N-cyclohexyl maleic imide and the like; unsaturated carboxylic acid ester such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, 2-hydrox vinyl acrylate, 2-hydroxy vinyl methacrylate, 2-hydroxy propyl acrylate, 2-hydroxy propyl methacrylate, 3-hydroxy propyl acrylate, 3-hydroxy propyl methacrylate, 2-hydroxy butyl acrylate, 2-hydroxy butyl methacrylate, 3-hydroxy butyl acrylate, 3-hydroxy butyl methacrylate, 4-hydroxy butyl acrylate, 4-hydroxy butyl mehacrylate, allyl acrylate, allyl methacrylate, methyl benzyl acrylate, methyl benzyl methacrylate, benzyl acrylate, benzyl methacrylate, methoxy triethylene glycol acrylate, methoxy triethylene glycol methacrylate, lauryl acrylate, lauryl methacrylate, tetradecyl acrylate, tetradecyl methacrylte, hexadecyl acrylate, hexadecyl methacrylate, octadecyl acrylate, octadecyl methacrylte, eicosyl acrylate, eicosyl methacrylate, docosyl acrylate, docosyl methacrylte and the like; unsaturated carboxylic ammonia alkyl ester such as 2-ammonia vinyl acrylate, 2-ammonia vinyl methacrylate, 2-ammonia propyl acrylate, 2-ammonia propyl mehacrylate, 3-ammonia propyl acrylate, 3-ammonia propyl methacrylate and the like; unsaturated carboxylic epoxypropyl ester such as epoxypropyl acrylate, epoxypropyl methacrylate and the like; carboxylic vinyl ester such as vinyl acetate, vinyl pivalate, vinyl butyrate, vinyl benzoate and the like; unsaturated ether such as vinyl methyl ether, vinyl ethyl ether, allyl glycidyl ether, methallyl glycidyl ether and the like; vinyl cyanide compound such as acrylonitrile, methacrylonitrile, α-chloroacrylonitrile, cyanide vinylidene and the like; unsaturated amide or unsaturated imide such as acrylamide, methacrylamide, α-chloro acrylamide, N-hydroxy vinyl acrylamide, N-hydroxy vinyl methacrylamide, maleic amide and the like; alicyclic conjugated diene such as 1,3-butadiene, isopropene, chloropropene, isoprene, chloroprene and the like; a end group in polymer chain having marcomonomer of mono-acrylyl group pr mono-methyl acrylyl group such as polystyrene, poly methyl acrylate, poly methyl methacrylate, polybutyl acrylate, polybutyl methacrylate, polysiloxane and the like. Among those monomers, acrylic acid, methacrylic acid, styrene, N-benzyl maleic imide, methyl acrylate, methyl methacrylate, n-butyl acrylate, 2-hydroxy ethyl acrylate, 2-hydroxy ethyl methacrylate, methyl benzyl acrylate, methyl benzyl methacrylate and the like are preferred. The aforementioned other copolymerizable vinyl unsaturated monomer (a-2) can be used alone or in combination of two or more.

Based on the acrylate-based resin having saturated alicyclic group (A) as 100 parts by weight, the usage amount of the other copolymerizable vinyl unsaturated monomer (a-2) is usually from 60 to 97 parts by weight, preferably from 65 to 96 parts by weight, and more preferably from 70 to 95 parts by weight.

The acrylate-based resin having the saturated alicyclic group (A) of the present invention can be obtained by uniformly mixing the acrylate-based monomer (a-1) and the other copoymerizable vinyl unsaturated monomer (a-2) through various conventional mixers or dispersers, adding 0.01 wt % to 3 wt % of polymeric initiators into the monomers and then performing polymerization under room temperature. In the above reaction, an organic solvent can be used optionally.

Specific examples of the polymeric initiators used above are: peroxides such as benzoyl peroxide, azoic compounds such as 2,2′-azobis (isobutyronitrile) (hereinafter abbreviated as AIBN), 2,2′-azobis (methylbutyronitrile) (hereinafter abbreviated as AMBN), and the like.

Appropriate organic solvents that are chosen herein are easily to dissolve with other organic components have specific examples as follows: (poly)alkylene glycol monoalkyl ethers such as ethylene glycol monomethyl ether, ethylene glycol monoethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether and the like; other ethers such as dipropylene glycol monomethyl ether, dipropylene glycol monoethyl ether, dipropylene glycol mono-n-propyl ether, dipropylene glycol mono-n-butyl ether, tripropylene glycol monomethyl ether, tripropylene glycol monoethyl ether and the like; esters of (poly)alkylene glycol monoalkyl ether acetate such as ethylene glycol monomethyl ether acetate, ethylene glycol monoethyl ether acetate, propylene glycol monomethyl ether acetate, propylene glycol monoethyl ether acetate and the like; other ethers such as diethylene glycol dimethyl ether, diethylene glycol methyl ethyl ether, diethylene glycol diethyl ether, tetrahydrofuran and the like; ketones such as methyl ethyl ketone, cyclohexanone, 2-heptanone, 3-heptanone and the like; alkyl lactate esters such as 2-hydroxy methyl propionate, 2-hydroxy ethyl propionate (ethyl lactate) and the like; other esters such as 2-hydroxy-2-methyl methyl propionate, 2-hydroxy-2-methyl ethyl propionate, methyl 3-methoxypropionate, ethyl 3-methoxypropionate, methyl 3-ethoxypropionate, ethyl 3-ethoxypropionate, ethoxy ethyl acetate, hydroxy ethyl acetate, 2-hydroxy-3-methyl methyl butyrate, 3-methyl-3-methoxy butyl acetate, 3-methyl-3-methoxy butyl propionate, acetic ether, n-propyl acetate, isopropyl acetate, n-butyl acetate, isobutyl acetate, n-amyl acetate, isoamyl acetate, n-butyl propionate, ethyl butyrate, butyric acid n-propyl ester, isopropyl butyrate, butyric acid n-butyl ester, methyl pyruvate, ethyl pyruvate, pyruvic acid n-propyl, acetyl methyl acetate, acetyl ethyl acetate, 2-oxo ethyl butyrate and the like; aromatic or aliphatic hydrocarbons such as methylbenzene, dimethylbenzene, hexane, cyclohexane, trimethylbenzene, diisopropylbenzene and the like; carboxylic acid amines such as N-methyl pyrrolidone, N,N-dimethylformamide, N,N-dimethylacetamide. The foregoing solvents can be used alone or in combinations of two or more. Among those solvents, propylene glycol monomethyl ether, propylene glycol monomethyl ether acetate, diethylene glycol dimethyl ether, ethyl lactate, 3-ethoxy ethyl propionate are preferred.

A weight-average molecule weight of the acrylate-based resin having the saturated alicyclic group (A) is usually from 60,000 to 120,000, preferably from 70,000 to 110,000, and more preferably from 80000 to 100,000. When the weight-average molecule weight is in the aforementioned range, the pattern-forming ink composition can further improve the color difference.

### Solvent (B)

There are no limitations specific to the kind of the solvent (B) used in the foregoing pattern-forming ink composition, which can be chosen from the solvents used in the polymerization process of the foregoing acrylate-based resin having the saturated alicyclic group (A) and are not illustrated any more here. Furthermore, the solvent preferably is propylene glycol monomethyl ether, propylene glycol monomethyl ether acetate, diethylene glycol dimethyl ether ethyl lactate or 3-ethoxy ethyl propionate. The solvent (B) can be used alone or in combinations of two or more.

There are no limitations specific to the usage amount of the foregoing solvent (B). Based on the acrylate-based resin having the saturated alicyclic group (A) as 100 parts by weight, the usage amount of the solvent (B) is usually from 100 to 500 parts by weight, preferably from 150 to 450 parts by weight, and more preferably from 200 to 400 parts by weight.

### Filling Material (C)

The filling material (C) of the present invention can be an organic filling material and/or an inorganic filling material. Specific examples of the organic filling material are: epoxy resin, melamine resin, urea resin, acrylate-based resin, phenolic resin, polyimide resin, polyamide resin, polyester resin and teflon resin and the like. Specific examples of the inorganic filling material are aluminum oxide, aluminum hydroxide silicon dioxide (for example, commercially available products made by Catalysts And Chemicals Industries Co., Ltd.: [for example, the trade names of OSCAR 1132 (the particle diameter is 12 nm; the dispersant is methanol), OSCAR 1332 (the particle diameter is 12 nm; the dispersant is to n-propanol). OSCAR 105 (the particle diameter is 60 nm; the dispersant is γ-butyrolactone), OSCAR 106 (the particle diameter is 120 nm; the dispersant is diacetone alcohol)]; the commercially available products made by Fuso Chemical Co. Ltd.: [for example, the trade names of Quartron PL-1-IPA (the particle diameter is 13 nm; the dispersant is isopropyl alcohol), Quartron PL-1-TOL (the particle diameter is 13 nm; the dispersant is toluene), Quartron PL-2L-PGME (the particle diameter is 18 nm; the dispersant is propylene glycol monomethyl ether), Quartron PL-2L-MEK (the particle diameter is 18 nm; the dispersant is methyl ethyl ketone)]; the commercially available products made by Nissan Chemical Industries, Ltd.: [for example, the trade names of IPA-ST (the particle diameter is 12 nm; the dispersant is isopropyl alcohol), EG-ST (the particle diameter is 12 nm; the dispersant is ethylene glycol), IPA-ST-L (the particle diameter is 45 nm; the dispersant is isopropyl alcohol), IPA-ST-ZL (the particle diameter is 100 nm; the dispersant is isopropyl alcohol)]); magnesium oxide, magnesium hydroxide, iron oxide, titanium dioxide, zinc oxide, stannic oxide, silicon nitride, aluminium nitride, talc [the commercially available products such as the trade name of SG-2000 (the average particle diameter is 1 μm, made by Nippon Talc Co., Ltd.)], mica, asbestos powder, quartz powder, kaolin, bentonite, diatomaceous earth, zeolite, gypsum, glass bead, glass fibre, barium sulfate, magnesium sulfate, calcium carbonate, magnesium carbonate, calcium silicate, aluminium silicate, zirconium silicate, potassium titanate and fullerene and the like. The aforementioned filling material (C) can be used alone or in combinations of two or more.

There are no limitations specific to the average particle diameter of the filling material (C) of the present invention, usually below 10 μm, preferably below 5 μm and more preferably below 3 μm. Based on the acrylate-based resin having the saturated alicyclic group (A) as 100 parts by weight, the usage amount of the filling material (C) is usually from 2 to 70 parts by weight, preferably from 5 to 60 parts by weight, and more preferably from 10 to 50 parts by weight.

### Additive (D)

The additive (D) such as silane coupling agents, defoamers, and dispersants can be selectively added into the pattern-forming ink composition of the present invention.

Specific examples of the aforementioned silane coupling agent are: vinyltrichloro silane, ethenyl triethoxysilane, vinyltris (β-methoxyethoxy)silane, β-(3,4-epoxy cyclohexyl)ethyl trimethoxy silane, 3-epoxy propoxy propyl trimethoxyl silane, γ-epoxy propoxy propyl methyl diethoxy silane, γ-methacryloxypropyltrimethoxysilane, N-(β-aminoethyl)-γ-aminopropyl trimethoxy silane, N-(β-aminoethyl)-γ-aminopropyl trimethyl dimethoxy silane, N-phenyl-γ-aminopropyl trimethoxy silane, γ-chloropropyl trimethoxysilane, γ-sulfhydryl propyl trimethoxy silane, γ-aminopropyl trimethoxy silane, bis-1,2-(trimethoxy silane)ethane, commercially available products such as the trade name of SZ 6030 (made by Dow Corning Toray Silicone) and the trade names of KBE-903, KBE-603, KBE-403 and KBM-403 (made by Shin-Etsu Chemical Co., Ltd.).

Based on the acrylate-based resin having the saturated alicyclic group (A) as 100 parts by weight, the content of the silane coupling agent is usually from 0 to 30 parts by weight, preferably from 3 to 25 parts by weight, and more preferably from 5 to 20 parts by weight.

Specific examples of the aforementioned defoamer are: Surfynol MD-20, Surfynol MD-30, Surfynol DF 110D, Surfynol 104E, Surfynol 420, Surfynol DF 37, Surfynol DF 58, Surfynol DF 66, Surfynol DF 70 and Surfynol DF 210 and EnviroGem AD01 EnviroGem AE01 and EnviroGem AE02 and the like (made by Air products). Based on the acrylate-based resin having the saturated alicyclic group (A) as 100 parts by weight, the content of the defoamer is usually from 1 to 10 parts by weight, preferably from 2 to 9 parts by weight, and more preferably from 3 to 8 parts by weight.

The aforementioned dispersant can be, for example, a polymeric dispersant, a poly-ethyoxyl alkyl phosphate, a poly-ethyoxyl alkylamine, an alkanolamine, a pigment derivative and the like. Specific examples of the polymeric dispersant are: polyamidoamine (salt), polycarboxylic acid (salt), unsaturated acid esters with high molecular weight, modified polyurethanes, modified polyesters, modified poly (methyl)acrylic ester, (methyl)acrylate copolymer, naphthalenesulfonic acid formaldehyde condensate and the like. The aforementioned polymeric dispersant can be further classified into a linear-type macromolecule, a terminus modified macromolecule, a grafted macromolecule and a block-type macromolecule according to the structure.

The foregoing dispersant also can use the commercial products, and the specific examples thereof are: commercially available products with the trade names of DISPERBYK-101, DISPERBYK-107, DISPERBYK-110, DISPERBYK-130, DISPERBYK-161, DISPERBYK-162, DISPERBYK-163, DISPERBYK-164, DISPERBYK-165, DISPERBYK-166, DISPERBYK-170, BYK-P104, BYK-P105 and the like (made by BYK Chemie GmbH); commercially available products with the trade names of EFKA 4047, EFKA 4010 to 4061, EFKA 4330 to 4340, EFKA 4400 to 4402, EFKA 5010, EFKA 6220, EFKA 6745 and the like (made by EFKA Frankl & Kirchner GmbH & Co KG); commercially available products with the trade names of AJISPER PB-821, AJISPER PB-822 and the like (made by Ajinomoto Fine—Techno Co., Inc.); commercially available products with the trade names of DISPARLON KS-860, DISPARLON KS-873N, DISPARLON 2150, DISPARLON 7004 and the like (made by Kusumoto Chemicals, Ltd.); commercially available products with the trade names of DEMOL RN, DEMOL N, DEMOL MS, DEMOL C, DEMOL SN-B, HOMOGENOL L-18, ACETAMIN 86 and the like (made by Kao Corporation); commercially available products with the trade names of SOLSPERSE 5000, SOLSPERSE 22000, SOLSPERSE 13240, SOLSPERSE 3000, SOLSPERSE 17000, SOLSPERSE 27000, SOLSPERSE 24000, SOLSPERSE 28000, SOLSPERSE 32000, SOLSPERSE 38500 and the like (made by Lubrizol Corporation), and a commercially available product with the trade name of HINOACT T-8000E (made by Kawaken Fine Chemicals Co., Ltd.).

The aforementioned additive (D can be used alone or in combinations of two or more.

### Preparation of Pattern-Forming ink Composition

The pattern-forming ink composition of the present invention is typically that the pattern-forming ink composition can be produced by uniformly mixing the aforementioned acrylate-based resin having the saturated alicyclic group (A) and the solvent (B), optionally with addition of the filling material (C) and/or various additives (D), in the conventional mixer or disperser.

A viscosity of the pattern-forming ink composition is usually from 20,000 cps to 100,000 cps, preferably from 30,000 cps to 90,000 cps, and more preferably from 40,000 cps to 80,000 cps. When the viscosity of the pattern-forming ink composition is in the aforementioned range, the light guide plate has a well coatability.

### Light Guide Plate

Reference is made to FIG. 1, which shows a cross-sectional and exploded diagram of a LCD device according to an embodiment of the present invention. In an embodiment, the LCD device 100 comprises a light guide plate 110, a light-emitting unit 120 and a liquid crystal panel 150.

The light guide plate 110 of the present invention includes a light incident surface 111, a light-emitting surface 113 and a bottom surface 115 opposite to the light-emitting surface 113. The light incident surface 111 is formed at one side of the light guide plate 110, and the bottom surface 115 and the light incident surface 111 are connected to each other at an oblique angle. Moreover, the thickness of the light guide plate 110 is decreased from one side of the light incident surface 111 to the other opposite side, so that the light is emitted uniformly from the light-emitting surface 113.

The aforementioned dot patterns 117 are formed on the bottom surface 115 of the light guide plate 110. There are no limitations specific to the arrangement or size of the dot patterns 117. The dot patterns 117 can let the incident light that passes through the incident light surface 111 to be scattered and reflected. That is to say, the light is diffused uniformly to various directions. For example, when the dot patterns 117 are printed, various different shapes such as circles, quadrilaterals or hexagons can be formed, and the light scattering level and brightness of the dot patterns 117 also can be changed depending upon the materials used in the ink.

### Light-Emitting Unit

Reference is made to FIG. 1 again, the light-emitting unit 120 of the present invention can include a light-emitting source 131 and the aforementioned light guide plate 110. The light guide plate 110 can be combined with the light-emitting source 131 laterally. The light incident surface 111 is opposite to the light-emitting source 131, so that the light (unshown) emitted from the light-emitting source 131 enters into the light guide plate 110 through the light incident surface 111, and the light is further projected towards the direction of the LCD panel 150 as directed by the light guide plate 110. The foregoing light-emitting source 131 includes a light source 133 and a reflective mask 135. The light source 133 can be a light-emitting diode of a point light source or a lamp of a line light source. An opening is configured at one side of the reflective mask 135 adjacent to the light guide plate 110, so that the light that is either directly emitted from the light source 133 or reflected by the reflective mask 135 enters into the light guide plate 110 through the opening of the reflective mask 135 and the light incident surface 111.

Additionally, the light-emitting unit 120 can further include an optical module 140. The optical module 140 includes multiple optical devices, such as a reflective sheet 141, a diffusion sheet 143, a prism sheet 145 and the like. The reflective sheet 141 is adjacent to the bottom surface 115 of the light guide plate 110, so that the light radiated out of the light guide plate 110 through the bottom surface 115 is reflected through the bottom surface 115 and passes into the light guide plate 110. The diffusion sheet 143 is adjacent to the light-emitting surface 113 of the light guide plate 110, so that the light passes through the light guide plate 110 and radiated from the light-emitting surface 113 can be diffused uniformly. The prism sheet 145 is adjacent to the diffusion sheet 143. The prism sheet 145 can condense the light to enhance the brightness of the front surface of the liquid crystal panel 150 to which the light is projected.

### Liquid Crystal Display (LCD) Device

Reference is made to FIG. 2, which shows a schematic perspective exploded diagram of a LCD device according to an embodiment of the present invention. The LCD device 200 of the present invention at least includes the aforementioned light-emitting unit 210, a liquid crystal panel 220, a top base plate 230 and a bottom base plate 240.

The liquid crystal panel 220 can include a thin film transistor (TFT) substrate 221 (hereinafter abbreviated as a TFT substrate), a color filter (CF) substrate 223 and a liquid crystal layer (unshown) containing liquid crystal, thereby displaying an external image.

Furthermore, a printed circuit board 225 is configured with a driving chip (unshown), and connected to the TFT substrate 221 through a tape carrier package 227. Various signals required for displaying the aforementioned external image can be delivered to the TFT substrate 221 through the printed circuit board 225 and the driving chip (unshown).

Additionally, the foregoing top base plate 230 can be connected with the bottom base plate 240. An open receiving space is formed at the upper part of the above bottom base plate 240. The liquid crystal panel 220 can be supported by a part of the bottom base plate 240 around the receiving space, and the receiving space can accommodate the aforementioned light-emitting unit 210. The light provided by the aforementioned light-emitting unit 210 can pass through the liquid crystal panel 220 and the liquid crystal panel 220 displays the external image.

The aforementioned top base plate 230 covers and fixes the outer edge of the liquid crystal panel 220 to prevent the printed circuit board 225 from exposing to the external environment. An opening is configured in the middle region of the top base plate 230, thereby exposing the image display region of the liquid crystal panel 220.

It is supplemented that, the present invention is illustrated by FIGS. 1 and 2 rather than being limited thereto. Therefore, the light-emitting unit of the present invention can be applied to other types of display apparatus; and it is also capable to use other types of optical devices, such as a polarized sheet or the like, in the LCD device of the present invention.

Several embodiments are described below to illustrate, the application of the present invention. However, these embodiments are not used for limiting the present invention. For those skilled in the art of the present invention, various variations and modifications can be made without departing from the spirit and scope of the present invention.

### BRIEF DESCRIPTION OF THE DRAWINGS

In order to make the foregoing as well as other aspects, features, advantages, and embodiments of the present invention more apparent, the accompanying drawings are described as follows:

FIG. 1 shows a cross-sectional and exploded diagram of a LCD device according to an embodiment of the present invention;

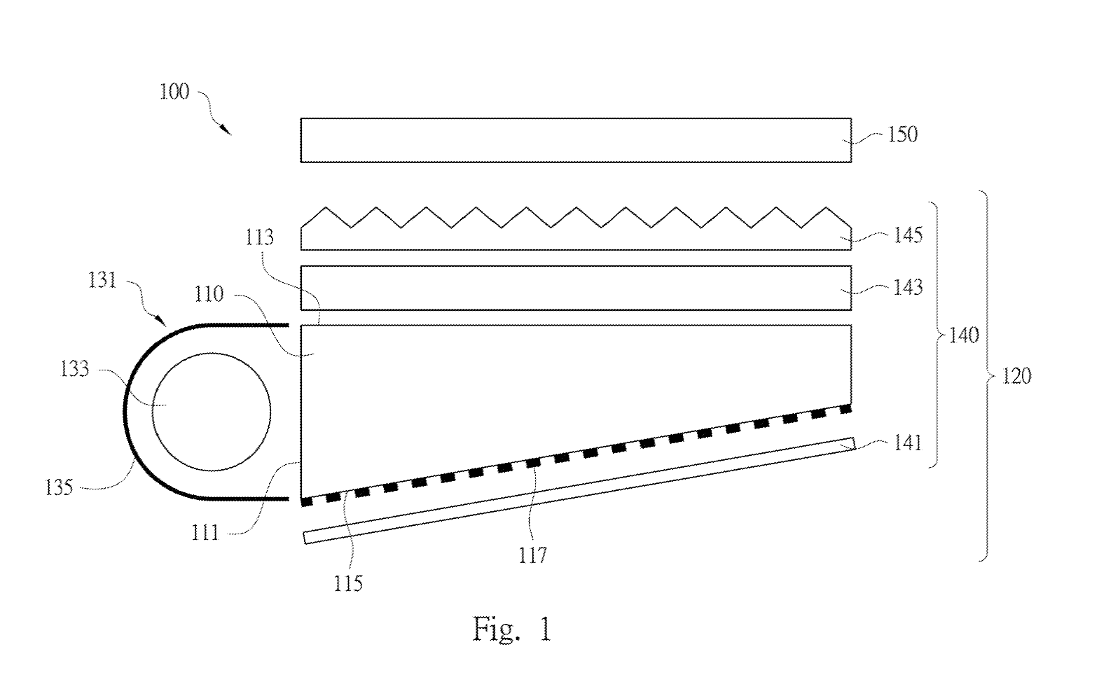

FIG. 2 shows a stereo exploded diagram of a LCD device according to an embodiment of the present invention; and

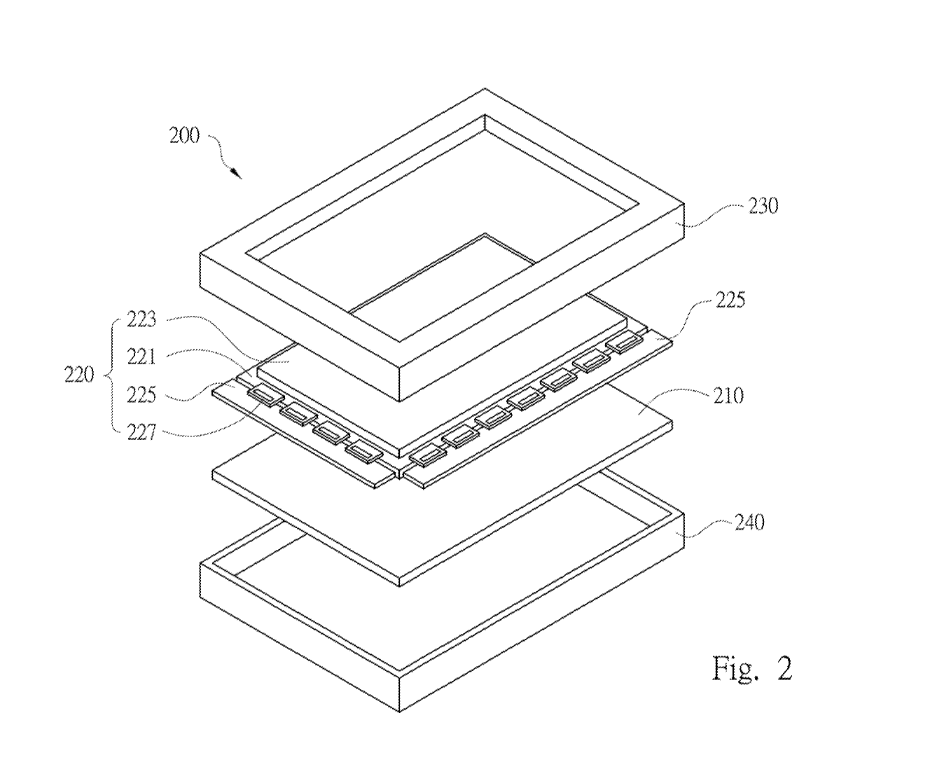

FIG. 3 shows a top view of an evaluation method of color difference according to an embodiment of the present invention.

### DETAILED DESCRIPTION

### Preparation of Acrylate-Based Resin Having Saturated Alicyclic Group (A)

Hereinafter, the acrylate-based resins having the saturated alicyclic group (A) of Synthesis Examples A-1 to A-7 are prepared according to Table 1 as follows.

### Synthesis Example A-1

10 parts by weight of adamantyl acrylate (hereinafter abbreviated as ADA), 55 parts by weight of n-butyl acrylate (hereinafter abbreviated as n-BA), 34 parts by weight of styrene (hereinafter abbreviated as SM) and 1 parts by weight of 2,2′-azobis(methylbutyronitrile) (hereinafter abbreviated as AMBN) were stirred uniformly by a planetary compulsory mixer (Model No. ARB-310; made by THINKY Corporation), followed by subjecting the reactant into a thermal polymerization reaction at 80° C. for 12 hours, thereby obtaining the acrylate-based resin having the saturated alicyclic group (A-1). The weight-average molecule weight of the acrylate-based resin having the saturated alicyclic group (A) was evaluated according the following evaluation methods, and the results thereof were listed as Table 1. The evaluation method of the weight-average molecule weight was described as follows.

### Synthesis Examples A-2 to A-7

Synthesis Examples A-2 to A-7 were synthesized with the same method as in Synthesis Example A-1 by using various kinds or usage amounts of the reactants for the acrylate-based resin having the saturated alicyclic group (A). The formulations of Synthesis Examples A-2 to A-7 were listed in Table 1 rather than focusing or mentioning them in details.

### Comparative Synthesis Example 1

10 parts by weight of 2-hydroxyethyl methacrylate, 55 parts by weight of n-BA, 34 parts by weight of SM and 1 parts by weight of AMBN were stirred uniformly by the planetary compulsory mixer, followed by subjecting the reactant into a thermal polymerization reaction at 80° C. for 12 hours, thereby obtaining the acrylate-based resin (PA-1).

### Comparative Synthesis Example 2

30 parts by weight of methyl methacrylate (hereinafter abbreviated as MMA), 50 parts by weight of n-BA, 3 parts by weight of epoxypropyl methacrylate, 16 parts by weight of SM and 1 parts by weight of AMBN were stirred uniformly by the planetary compulsory mixer, followed by subjecting the reactant into a thermal polymerization reaction at 80° C. for 12 hours, thereby obtaining the acrylate-based resin (PA-2).

### Comparative Synthesis Example 3

5 parts by weight of MMA, 44 parts by weight of n-BA, 50 parts by weight to of SM and 1 parts by weight of AMBN were stirred uniformly by the planetary compulsory mixer, followed by subjecting the reactant into a thermal polymerization reaction at 80° C. for 12 hours, thereby obtaining the acrylate-based resin (PA-3).

### Preparation of Pattern-Forming Ink Composition

The pattern-forming ink compositions of Examples 1 to 7 and Comparative Examples 1 to 3 were prepared according to Table 2 as follows.

### Example 1

100 parts by weight of the acrylate-based resin having the saturated alicyclic group (A-1) and 280 parts by weight of diethyleneglycol dimethyl ether (hereinafter abbreviated as B-1) were stirred uniformly by the planetary compulsory mixer, followed by compounding the reactant by a three drum roller (Model No, FC-90 mm, made by Farn Chang Co., Ltd.) for 3 hours, thereby obtaining the pattern-forming ink composition. The resulted pattern-forming ink composition was evaluated according to the following evaluation methods, and the result thereof was listed as Table 2. The detection methods of the viscosity, coatability and the color difference were described as follows

### Examples 2 to 7

Examples 2 to 7 were practiced with the same method as in Example 1 by using various kinds or usage amounts of the components for the pattern-forming ink composition. The formulations and detection results thereof were listed in Table 2 rather than focusing or mentioning them in details.

### Comparative Examples 1 to 3

Comparative examples 1 to 3 were practiced with the same method as in Example 1 by using various kinds or usage amounts of the components for the pattern-forming ink composition. The formulations and detection results thereof were also listed in Table 2 rather than focusing or mentioning them in details.

### Evaluation Methods

### 1. Weight-Average Molecule Weight

The weight-average molecule weight of the acrylate-based resin having the saturated alicyclic group (A) was measured by gel permeation chromatography (GPC) according to the following conditions.

Columns of GPC (Model No. 717 plus, made by Waters Co., Ltd.) were the commercially available products such as 79911GP-501, 79911GP-502, 79911GP-503 and 79911GP-504 and the columns that were made by Agilent Technologies. The detector was the commercially available equipment such as 2414 RI Detector (made by Waters Co., Ltd.). Mobile phase was tetrahydrofuran with the flow rate of 1.0 mL/min, and the injected amount of the acrylate-based resin having the saturated alicyclic group (A) was 100 μL. In addition, the GPC was kept at a temperature of 40° C. during detection. Polystyrene served as the molecular-weight standard. The measured weight-average molecule weight was shown in Table 1.

### 2 Viscosity

The viscosity of the pattern-forming ink composition was measurement by a rotary viscosimeter (Model No. DV-E, made by BROOKFIELD Co., Ltd.) at 100 rpm under 25° C. of a constant temperature. The measured viscosity was shown in Table 2.

### 3. Coatability

The pattern-forming ink composition was printed as dots with the area of 300 mm² onto the light guide plate (made by transparent PMMA resin; 3 mm in thickness; 32 inch in size) by using a screen printer (Model No. PA3-F34, made by BUILT-IN PRECISION MACHINE Co. Ltd.). A size error of the printed dots was calculated according to the following formula (I), and an evaluation was made according to the following criterion.

$$Size Error ( \% ) = ( \frac{the measurement area of the dot - 300}{300} ) \times 100 \qquad ( I )$$

⊚: the dot was printed completely and the percentage of the dots with the size error of larger than 20% was less than 1%.

◯: the dot was printed completely and the percentage of the dots with the size error of larger than 20% was 1% to 5%.

Δ: the dot was printed completely and the percentage of the dots with the size error of larger than 20% was larger than 5%.

X: the dot was printed incompletely due to ink leakage or ink clogged in the screen.

### 4. Color Difference

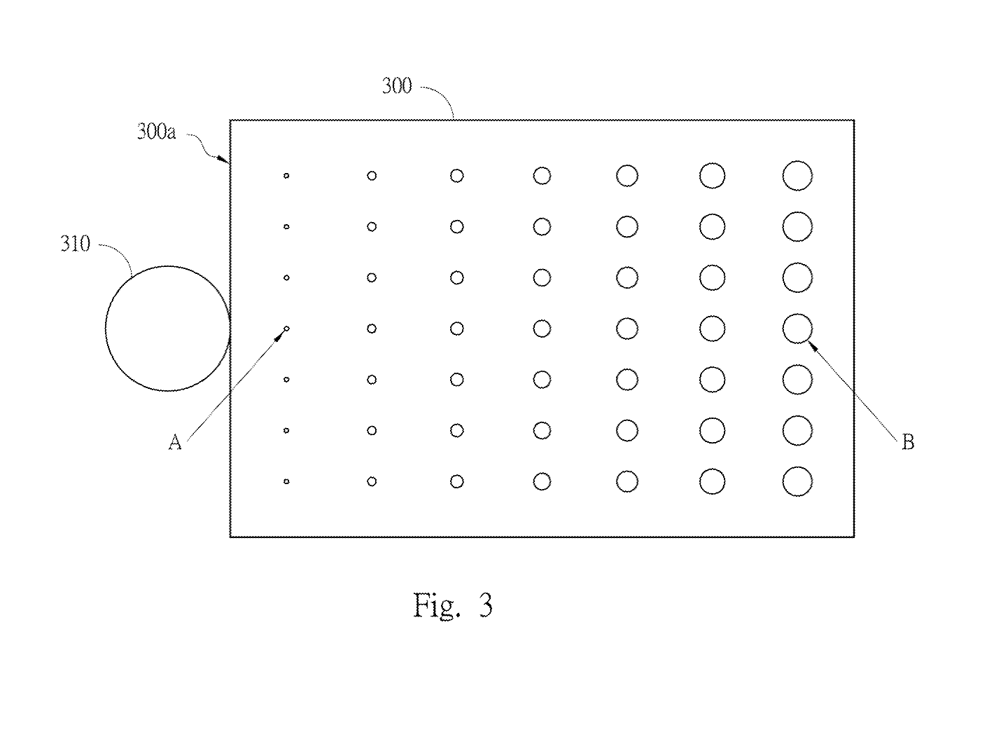

Reference is made to FIG. 3, which shows a top view of the evaluation method of the color difference according to an embodiment of the present invention. Firstly, the pattern-forming ink compositions were printed as dots with the areas of 300 mm², 400 mm², 500 mm², 600 mm², 700 mm², 800 mm² and 900 mm² sequentially onto the light guide plate 300 (made by transparent PMMA resin; 3 mm in thickness; 32 inches in size) from the light source end by using a screen printer (Model No. PA3-F34, made by BUILT-IN PRECISION MACHINE Co., Ltd.). Next, the light guide plate printed with the pattern-forming ink composition was dried at 70° C. for 30 minutes, and then the light guide plate 300 was irradiated by a LED 9000K light source 310 for 1 hour. The chromaticities of measured points (A and B) were measured by using a brightness photometer (Model No. BM-7A, made by Technohouse Corporation). A color difference (‰) was calculated according to following formula (II), and an evaluation was made according to the following criterion. In which, a distance between the measured point A and its nearer edge of the light guide plate, or another distance between the measured point B and its nearer edge of the light guide plate, was 20 mm.

Color Difference(‰)=|(y_{B}−y_{A})|×1000 (II)

In the formula (II), y_{A} represented the chromaticity coordinate (y_{A}) of the measurement point A, and y_{B} represented the chromaticity coordinate (y_{B}) of the measurement point B.

⊚: color difference<10‰

◯: 10‰≦color difference<13‰

Δ: 13‰≦color difference<15‰

X: 15‰≦color difference

The evaluation results of the weight-average molecule weight of the acrylate-based resin having the saturated alicyclic group (A) of the Synthesis Examples were shown in Table 1, and the evaluation results of the viscosity, coatability and color difference of the pattern-forming ink composition of the above Examples and Comparative Examples were shown in Table 2.

As shown in Table 1 and 2, when the pattern-forming ink composition included the acrylate-based resin having the saturated alicyclic group (A), the resulted light guide plate has lower color difference.

Moreover, when the weight-average molecule weight of the acrylate-based resin having the saturated alicyclic group (A) was form 60,000 to 120,000, the resulted light guide plate had much lower color difference. Furthermore, when the viscosity of the pattern-forming ink composition was from 20,000 cps to 100,000 cps, the pattern-forming ink composition had better coatability in coating onto the light guide plate, thereby achieving the purpose of the present invention.

### Comparative Example 4

In addition, according to embodiments of Japanese Patent Laid-Open Publication No, 2008-95103, the pattern-forming ink composition could be made by stirring 25 parts by weight of polymethyl methacrylate (about 30,000 of molecular weight), 5 parts by weight of hexamethylene diisocyanate, 40 parts by weight of acrylic beads (5 μm of average particle diameter), 10 parts by weight of dimethyl ether and 20 parts by weight of cyclohexanone were stirred uniformly by the planetary compulsory mixer and then compounded by the three drum roller for 3 hours. The resulted pattern-forming ink composition was also evaluated according to the aforementioned evaluation methods. However, the resulted color difference from the Comparative Example 4 was evaluated as “X”.

It should be supplemented that, although specific compounds, components, specific reactive conditions, specific processes, specific evaluation methods or specific equipments are employed as exemplary embodiments of the present invention, for illustrating the light guide plate, the light-emitting unit and the LCD device having the light-emitting unit of the present invention. However, as is understood by a person skilled in the art instead of limiting to the aforementioned examples, the light guide plate, the light-emitting unit and the LCD device having the light-emitting unit of the present invention also can be manufactured by using other compounds, components, reactive conditions, processes, analysis methods and equipment without departing from the spirit and scope of the present invention.

As is understood by a person skilled in the art, the foregoing preferred embodiments of the present invention are illustrated of the present invention rather than limiting of the present invention. In view of the foregoing, it is intended to cover various modifications and similar arrangements included within the spirit and scope of the appended claims. Therefore, the scope of which should be accorded the broadest interpretation so as to encompass all such modifications and similar structure.

TABLE 1

| | Acrylate-based Monomer Having an | | | | | | | | | |
|---|---|---|---|---|---|---|---|---|---|---|
| | Ester Group of a Saturated Alicyclic | | | | | | | | | Weight- |
| | Hydrocarbon Group of 5 to 22 Carbon | | | Copoymerizable Vinyl Unsaturated | | | Polymerization | Reaction | | average |
| Synthesis | Atoms (a-1) | | | Monomer (a-2) | | | Initiator | Temperature | Polymerization | Molecule |
| Example | ADA | IBMA | TCHMA | MMA | n-BA | SM | AMBN | (° C.) | Time (hr) | Weight |
| A-1 | 10 | | | | 55 | 34 | 1 | 80 | 12 | 46,000 |
| A-2 | 30 | | | 25 | 4 | 40 | 1 | 80 | 24 | 64,000 |
| A-3 | 40 | | | 15 | 44 | | 1 | 80 | 18 | 60,000 |
| A-4 | | 10 | 5 | | 34 | 50 | 1 | 70 | 12 | 130,000 |
| A-5 | 5 | 15 | | 45 | 34 | | 1 | 75 | 24 | 120,000 |
| A-6 | | 3 | | 30 | 50 | 16 | 1 | 75 | 12 | 75,000 |
| A-7 | 5 | | 20 | 30 | | 44 | 1 | 80 | 20 | 62,000 |

ADA Adamantyl acrylate
IBMA Isobornyl methacrylate
TCHMA Trimethyl cyclohexyl methacrylate
MMA Methyl methacrylate
n-BA n-butyl acrylate
SM Styrene
AMBN 2,2′-azobis(methylbutyronitrile)

TABLE 2

| | | Examples | | | | | | | Comparative Examples | | |
|---|---|---|---|---|---|---|---|---|---|---|---|
| Components | | 1 | 2 | 3 | 4 | 5 | 6 | 7 | 1 | 2 | 3 |
| Acrylate-based Resin | A-1 | 100 | | | | | | | | | |
| Having Saturated | A-2 | | 100 | | | | | | | | |
| Alicyclic Group (A) | A-3 | | | 100 | | | | | | | |
| (parts by weight) | A-4 | | | | 100 | | | | | | |
| | A-5 | | | | | 100 | | | | | |
| | A-6 | | | | | | 100 | | | | |
| | A-7 | | | | | | | 100 | | | |
| Acrylate-based Resin | PA-1 | | | | | | | | 100 | | |
| (parts by weight) | PA-2 | | | | | | | | | 100 | |
| | PA-3 | | | | | | | | | | 100 |
| Solvent (B) | B-1 | 280 | | 400 | 200 | 300 | | | 280 | | 400 |
| (parts by weight) | B-2 | | 300 | | | 50 | | 250 | | 300 | |
| | B-3 | | | | 50 | | 160 | | | | |
| Filling Material (C) | C-1 | | | 10 | | | | | | | 10 |
| (parts by weight) | C-2 | | | | | | | 5 | | | |
| Additive (D) | D-1 | | 5 | | | | 3 | | | 5 | |
| (parts by weight) | D-2 | | | | 1 | | 0.5 | | | | |
| Evaluation Methods | Viscosity | 84,000 | 18,000 | 16,000 | 94,000 | 78,000 | 113,000 | 16,000 | 82,000 | 91,000 | 18,000 |
| | Coatability | ⊚ | ◯ | ◯ | ⊚ | ⊚ | ◯ | ⊚ | ⊚ | ⊚ | ◯ |
| | Color Difference | ◯ | ⊚ | ⊚ | ◯ | ⊚ | ⊚ | ⊚ | X | X | X |

B-1 Diethyleneglycol dimethyl ether
B-2 Propyleneglycolmonomethylether
B-3 Ethyl 3-ethoxypropionate
C-1 IPA-ST, silicon dioxide (average particle diameter is 12 nm, made by Nissan Chemical Industries, LTD.)
C-2 SG-2000, talc (1 μm of average particle diameter, made by Nippon Talc Co., Ltd.)
D-1 KBM-403, 3-glycidoxypropyltrimethoxy silane (made by Shin-Etsu Chemical Co., LTD.)
D-2 Disperbyk-101 (made by BYK Chemie Gmbh)

What is claimed is:

1. A light guide plate, comprising:
a light incident surface of incident light;
a light-emitting surface of emergent light; and
a bottom surface opposite to the light-emitting surface, wherein the bottom surface has a light guide layer; and
wherein the light guide layer includes a pattern-forming ink composition that is coated and dried on the bottom surface of the light guide plate, so as to form dot patterns as the light guide layer, and the pattern-forming ink composition comprises:
an acrylate-based resin having a saturated alicyclic group (A); and
a solvent (B).

2. The light guide plate of claim 1, wherein the acrylate-based resin having a saturated alicyclic group (A) is copolymerized by an acrylate-based monomer (a-1) and a copolymerizable vinyl unsaturated monomer (a-2), and the acrylate-based monomer (a-1) has an ester group of a saturated alicyclic hydrocarbon group of 5 to 22 carbon atoms.

3. The light guide plate of claim 1, wherein a molecule weight of the acrylate-based resin having the saturated alicyclic group (A) is 60,000 to 120,000.

4. The light guide plate of claim 1, wherein a viscosity of the pattern-forming ink composition is 20,000 cps to 100,000 cps.

5. A light-emitting unit, comprising:
a light-emitting source; and
a light guide plate combined with the light-emitting source, wherein a bottom surface of the light guide plate has a light guide layer; and
wherein the light guide layer includes a pattern-forming ink composition that is coated and dried on the bottom surface of the light guide plate, so as to form dot patterns as the light guide layer, wherein the pattern-forming ink composition comprises:
an acrylate-based resin having a saturated alicyclic group (A); and
a solvent (B).

6. The light-emitting unit of claim 5, wherein the acrylate-based resin having a saturated alicyclic group (A) is copolymerized by an acrylate-based monomer (a-1) and a copolymerizable vinyl unsaturated monomer (a-2), and the acrylate-based monomer (a-1) has an ester group of a saturated alicyclic hydrocarbon group of 5 to 22 carbon atoms.

7. The light-emitting unit of claim 5, wherein a molecule weight of the acrylate-based resin having the saturated alicyclic group (A) is 60,000 to 120,000.

8. The light-emitting unit of claim 5, wherein a viscosity of the pattern-forming ink composition is 20,000 cps to 100,000 cps.

9. A liquid crystal display (LCD) device, comprising:
a light-emitting source;
a light guide plate combined with the light-emitting source, wherein a bottom surface of the light guide plate has a light guide layer; and
a liquid crystal panel configured above a light-emitting surface of the light guide plate; and
wherein the light guide layer includes a pattern-forming ink composition that is coated and dried on the bottom surface of the light guide plate; so as to form dot patterns as the light guide layer, and the pattern-forming ink composition comprises:
an acrylate-based resin having a saturated alicyclic group (A); and
a solvent (B).

10. The liquid crystal display of claim 9, wherein the acrylate-based resin having a saturated alicyclic group (A) is copolymerized by an acrylate-based monomer (a-1) and a copolymerizable vinyl unsaturated monomer (a-2), and the acrylate-based monomer (a-1) has an ester group of a saturated alicyclic hydrocarbon group of 5 to 22 carbon atoms.

11. The liquid crystal display of claim 9, wherein a molecule weight of the acrylate-based resin having the saturated alicyclic group (A) is 60,000 to 120,000.

12. The liquid crystal display of claim 9, wherein a viscosity of the pattern-forming ink composition is 20,000 cps to 100,000 cps.
